(19) United States
(12) Patent Application Publication
(10) Pub. No.: US 2023/0365144 A1
(43) Pub. Date: Nov. 16, 2023

(54) CONTROL ARITHMETIC DEVICE

(71) Applicant: Mitsubishi Electric Corporation, Tokyo (JP)

(72) Inventors: Tomoki UNO, Tokyo (JP); Rin ITO, Tokyo (JP); Shota KAMEOKA, Tokyo (JP); Ryota OKAMOTO, Tokyo (JP)

(73) Assignee: Mitsubishi Electric Corporation, Tokyo (JP)

(21) Appl. No.: 18/029,143

(22) PCT Filed: Nov. 27, 2020
(86) PCT No.: PCT/JP2020/044154

§ 371 Date: Mar. 29, 2023

(51) Int. Cl. B60W 50/04

(52) U.S. Cl. CPC B60W 50/045; B60W 2050/0043

(57) ABSTRACT

A control arithmetic device comprises a mixed state equation generation unit to generate a plurality of vehicle state equations each including one or more first state variables that are acquisition targets of one or more internal sensors installed in a vehicle, and generate a first mixed state equation by weighting each of the vehicle state equations using a first weighting function, a vehicle state acquisition unit to acquire a current value of each first state variable by the one or more internal sensors, a target route generation unit to generate a target route of the vehicle based on peripheral information acquired by one or more external sensors installed in the vehicle, and a target value arithmetic unit to calculate a target control value for the vehicle to travel along the target route based on the first mixed state equation and the current value of each first state variable, and output the target control value to a control unit that controls the vehicle.

### TECHNICAL FIELD

The present disclosure relates to a control arithmetic device that calculates a target control value for controlling an ego vehicle in autonomous driving.

### BACKGROUND ART

Patent Document 1 discloses a vehicle control device that calculates a target control value for controlling an ego vehicle on the basis of an evaluation function that evaluates a relationship between a future behavior of the ego vehicle predicted using a motion model of the ego vehicle and future behavior of other vehicles predicted using sensors.

### CITATION LIST

### Patent Document

Patent Document 1: Japanese Patent Application Publication Laid-open, No. 2017-84110

### SUMMARY OF INVENTION

Problems to be Solved by Invention

However, in Patent Document 1 a two wheel model that is a simplified model is used in order to reduce a calculation load in predicting a future behavior of the ego vehicle. However, for example, when a two wheel model that well expresses an actual behavior of the ego vehicle at a high vehicle speed is used, there is a difference from the actual behavior of the ego vehicle in a low-vehicle speed. Thus, when a target value is calculated using the two wheel model, it is possible to cause a driver to feel unnatural. In contrast, it is conceivable to use a four wheel model that well expresses an actual behavior of the ego vehicle at all vehicle speeds, but there is a problem in that the model becomes complicated and the calculation load increases.

The present disclosure has been made to solve the above-described problem, and an object of the present disclosure is to provide a control arithmetic device that accurately calculates a target control value for controlling an ego vehicle while an increase in the calculation load is suppressed.

### Means for Solving Problems

A control arithmetic device according to the present disclosure includes a mixed state equation generation unit to generate a plurality of vehicle state equations each including one or more first state variables that are acquisition targets of one or more internal sensors installed in a vehicle, and generate a first mixed state equation by weighting each of the vehicle state equations using a first weighting function, a vehicle state acquisition unit to acquire a current value of each of the first state variables by the one or more internal sensors, a target route generation unit to generate a target route of the vehicle based on peripheral information acquired by one or more external sensors installed in the vehicle, and a target value arithmetic unit to calculate a target control value for the vehicle to travel along the target route based on the first mixed state equation and the current value of each of the first state variables, and output the target control value to a control unit that controls the vehicle.

### Effect of Invention

According to the present disclosure, the control arithmetic device generates the first mixed state equation by weighting the plurality of vehicle state equations using the first weighting function and calculates the target control value for controlling an ego vehicle using the first mixed state equation. Therefore, it is possible to accurately calculate the target control value while an increase in the calculation load is suppressed.

### BRIEF DESCRIPTION OF DRAWINGS

FIG. 1 is a block diagram showing an example of a control arithmetic device according to Embodiment 1.

FIG. 2 is a schematic diagram showing an example of a first vehicle motion model in Embodiment 1 to Embodiment 3.

FIG. 3 is a schematic diagram showing an example of a second vehicle motion model in Embodiment 1 to Embodiment 3.

FIG. 4 is a graph showing an example of a first weighting function with respect to a vehicle speed in Embodiment 1 to Embodiment 3.

FIG. 5 is a graph showing an example of a yaw rate with respect to a vehicle speed in Embodiment 1.

FIG. 6 is a flowchart showing an example of a procedure of autonomous driving in Embodiment 1.

FIG. 7 is a block diagram showing an example of a control arithmetic device according to Embodiment 2.

FIG. 8 is a flowchart showing an example of a procedure of autonomous driving in Embodiment 2.

FIG. 9 is a flowchart showing another example of a procedure of autonomous driving in Embodiment 2.

FIG. 10 is a block diagram showing an example of a control arithmetic device according to Embodiment 3.

FIG. 11 is a flowchart showing an example of a procedure of autonomous driving in Embodiment 3.

FIG. 12 is a diagram showing a hardware configuration of a control arithmetic device and a control unit in Embodiment 1 to Embodiment 3.

### MODES FOR CARRYING OUT INVENTION

Hereinafter, a control arithmetic device according to embodiments of the present disclosure will be described with reference to the drawings. Note that an ego vehicle is simply referred to as a “vehicle” in the following description.

### Embodiment 1

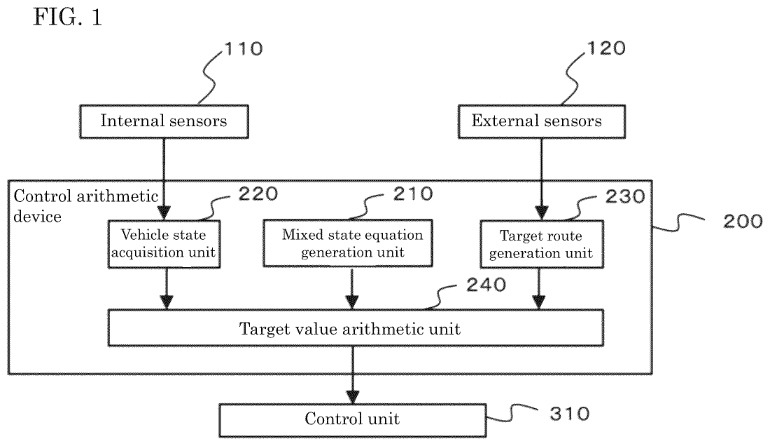

FIG. 1 is a block diagram showing an example of a control arithmetic device 200 according to Embodiment 1. FIG. 1 is a block diagram including internal sensors 110, external sensors 120, the control arithmetic device 200, and a control unit 310. The control arithmetic device 200 calculates target control values for controlling a vehicle on the basis of vehicle information from the internal sensors 110 and peripheral information from the external sensors 120. Here, the target control values are a target steering amount and a target acceleration/deceleration amount.

The internal sensors 110 are installed in the vehicle and output vehicle information. The internal sensors 110 are, for example, a steering angle sensor, a steering torque sensor, a yaw rate sensor, a vehicle speed sensor, an acceleration sensor, a global navigation satellite system (GNSS) sensor, or the like. The number of pieces of vehicle information that can be acquired by one of the internal sensors 110 is one. For example, the acceleration sensor acquires the longitudinal acceleration of the vehicle. Therefore, the number of pieces of vehicle information that can be acquired increases as the number of internal sensors 110 increases. Instead, an internal sensor 110 capable of acquiring a plurality of pieces of vehicle information may be installed in the vehicle.

The external sensors 120 are installed in the vehicle and output peripheral information of the vehicle. The external sensors 120 are, for example, a front camera that detects a position, an angle, and a curvature of a road section line, a radar that acquires a position and a speed of a preceding vehicle, a light detection and ranging (LiDAR), a sonar, a vehicle-to-vehicle communication device, a road-to-vehicle communication device, or the like. The peripheral information is, for example, positions and speeds of other vehicles, bicycles, pedestrians, and the like. Using the multiple external sensors 120 and integrating information from each of the external sensors 120, a plurality of pieces of peripheral information can be acquired at the same time. As an example, using a front camera, a radar, and a LiDAR as the external sensors 120 and integrating the information from each of the external sensors 120, positions and speeds of other vehicles can be acquired.

The control arithmetic device 200 includes a mixed state equation generation unit 210, a vehicle state acquisition unit 220, a target route generation unit 230, and a target value arithmetic unit 240.

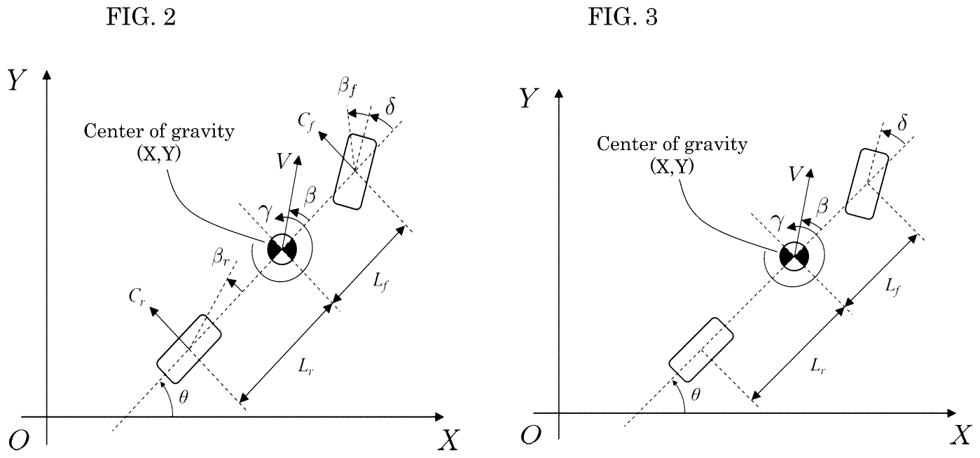

The mixed state equation generation unit 210 generates a plurality of vehicle state equations each including one or more first state variables that are acquisition targets of the internal sensors 110 installed in the vehicle. The mixed state equation generation unit 210 generates a first mixed state equation by weighting each of the vehicle state equations using a first weighting function. The mixed state equation generation unit 210 outputs the first mixed state equation to the target value arithmetic unit 240. The vehicle state equations here are a first vehicle state equation and a second vehicle state equation, which will be described in detail later with reference to FIG. 2 and FIG. 3. The first weighting function and the first mixed state equation will also be described in detail later.

The vehicle state acquisition unit 220 acquires a current value of each first state variable by the internal sensors 110. The vehicle state acquisition unit 220 outputs the current value of each first state variable to the target value arithmetic unit 240.

The target route generation unit 230 generates a target route of the vehicle on the basis of the peripheral information acquired by the external sensors 120 installed in the vehicle. The target route is, for example, a route to travel in the center of a lane, a route for performing lane changes, or the like. The target route generation unit 230 outputs the target route to the target value arithmetic unit 240.

The target value arithmetic unit 240 calculates target control values for the vehicle to travel along the target route on the basis of the first mixed state equation and the current value of each first state variable, and outputs the target control values to the control unit 310 that controls the vehicle. The target value arithmetic unit 240 will be described in detail later.

The control unit 310 is a controller mounted on the vehicle and operates an actuator so that the vehicle can follow the target control values from the target value arithmetic unit 240. The control unit 310 includes, for example, an electric power steering (EPS) controller, an engine controller, and a brake controller. The actuator is a motor indirectly connected to wheels, and performs steering, rotation, braking of the wheels, and the like.

Next, the vehicle state equations will be described with reference to FIG. 2 and FIG. 3.

FIG. 2 is a schematic diagram showing an example of a first vehicle motion model in Embodiment 1. In FIG. 2, the horizontal axis X and the vertical axis Y indicate the position of the center of gravity of a vehicle in the inertial coordinate system. θ is an azimuth angle, V is a vehicle speed, γ is a yaw rate, δ is a front wheel steering angle, β is a sideslip angle, β_{f} is a front wheel sideslip angle, βᵣ is a rear wheel sideslip angle, C_{f} is a cornering force of the front wheel, Cᵣ is a cornering force of the rear wheel, L_{f} is a distance between the center of gravity of the vehicle and the front wheel, and Lᵣ is a distance between the center of gravity of the vehicle and the rear wheel.

The first vehicle motion model is a two wheel model specialized for a high vehicle speed, and is a dynamic model using a motion equation related to a lateral motion of and a rotational motion about the position of the center of gravity of the vehicle. This model can calculate a vehicle motion depending on forces generated at tires, and thus can accurately express a vehicle motion at a high vehicle speed at which a lateral acceleration is generated particularly at the time of turning. The first vehicle motion model is represented below using the first vehicle state equation.

A vehicle state quantity x and a control input quantity u of the first vehicle state equation are defined by Expression (1) and Expression (2) below.

x=[X,Y,θ,V,γ,β,δ,αₓ]^{T} (1)

u=[ω,jₓ]^{T} (2)

In Expression (1) and Expression (2), aₓ is a longitudinal acceleration, ω is a front wheel steering angular velocity, and jₓ is a longitudinal jerk. Further, X, Y, θ, V, γ, β, δ, and aₓ, which are variables of the vehicle state quantity x in Expression (1), are the first state variables that are acquisition targets of the internal sensors 110. As shown by Expression (1), the number of the first state variables is multiple, but may be one. Note that, in Expression (1) and Expression (2), the vehicle state quantity x and the control input quantity u are each a column vector, and a transposed matrix is used for the sake of simplicity. The first vehicle state equation using variables in Expression (1) and Expression (2) is shown below in Expression (3).

$$\dot{x} = [ \begin{matrix}V cos ( θ + β ) \\ V sin ( θ + β ) \\ γ \\ {a}_{x} \\ \frac{2}{I} ( {L}_{f} {C}_{f} - {L}_{r} {C}_{r} ) \\ - γ + \frac{2}{M V} ( {C}_{f} + {C}_{r} ) \\ ω \\ {j}_{x}\end{matrix} ] \qquad ( 3 )$$

In Expression (3), \dot{x} is a time derivative of the vehicle state quantity x, I is a yaw moment of inertia of the vehicle, and M is mass of the vehicle. The cornering force C_{f} of the front wheel and the cornering force Cᵣ of the rear wheel are expressed by Expression (4) and Expression (5) below using a cornering stiffness K_{f} of the front wheel and a cornering stiffness Kᵣ of the rear wheel.

$${C}_{f} = - {K}_{f} ( β + \frac{{L}_{f}}{V} γ - δ ) \qquad ( 4 )$$

$${C}_{r} = - {K}_{r} ( β - \frac{{L}_{r}}{V} γ ) \qquad ( 5 )$$

When Expression (4) and Expression (5) are substituted into Expression (3), the first vehicle state equation is represented by Expression (6) below.

$$\dot{x} = {f}_{1} ( x , u ) = [ \begin{matrix}V cos ( θ + β ) \\ V sin ( θ + β ) \\ γ \\ {a}_{x} \\ \begin{matrix}- \frac{2}{IV} ( {K}_{f} {L}_{f}^{2} + {K}_{r} {L}_{r}^{2} ) γ - \\ \frac{2}{I} ( {K}_{f} {L}_{f} - {K}_{r} {L}_{r} ) β + \frac{2}{I} {K}_{f} {L}_{f} δ\end{matrix} \\ \begin{matrix}- ( 1 + \frac{2 ( {K}_{f} {L}_{f} - {K}_{r} {L}_{r} )}{M {V}^{2}} ) γ - \\ \frac{2}{M V} ( {K}_{f} + {K}_{r} ) β + \frac{2 {K}_{f}}{M V} δ\end{matrix} \\ ω \\ {j}_{x}\end{matrix} ] \qquad ( 6 )$$

In Expression (6), f₁ is a vector function of the first vehicle state equation.

FIG. 3 is a schematic diagram showing an example of a second vehicle motion model in Embodiment 1. The variables shown in FIG. 3 are the same as the variables described with reference to FIG. 2.

The second vehicle motion model is a two wheel model specialized for a low vehicle speed and is a geometric model of the vehicle. Unlike the first vehicle motion model, this model does not include the forces generated at the tires and can accurately express a vehicle motion at a low vehicle speed such as a vehicle turning along the direction of the tires. Hereinafter, the second vehicle motion model is represented using the second vehicle state equation.

In the second vehicle state equation, the vehicle state quantity x and the control input quantity u in Expression (1) and Expression (2) are used; that is, the same vehicle state quantity x and control input quantity u as those in the first vehicle state equation are used. The second vehicle state equation is represented by Expression (7) below.

$$\dot{x} = [ \begin{matrix}\begin{matrix}\begin{matrix}\begin{matrix}\begin{matrix}\begin{matrix}\begin{matrix}V cos ( θ + β ) \\ V sin ( θ + β )\end{matrix} \\ γ\end{matrix} \\ {a}_{x}\end{matrix} \\ \frac{{γ}_{k m} - γ}{τ}\end{matrix} \\ \frac{{β}_{k m} - β}{τ}\end{matrix} \\ ω\end{matrix} \\ {j}_{x}\end{matrix} ] \qquad ( 7 )$$

In Expression (7), τ is a time constant for the yaw rate and the sideslip angle, and γₖₘ and βₖₘ are the yaw rate and the sideslip angle, respectively, which can be calculated by the two wheel model using a geometric relationship. The time constant τ may be different values for the yaw rate and the sideslip angle, and the yaw rate γₖₘ and the sideslip angle βₖₘ are expressed by Expression (8) and Expression (9) below, respectively.

$${γ}_{k m} = \frac{V}{{L}_{f} + {L}_{r}} tan ( δ ) \qquad ( 8 )$$

$${β}_{k m} = {tan}^{- 1} ( \frac{{L}_{r}}{{L}_{f} + {L}_{r}} tan ( δ ) ) \qquad ( 9 )$$

When Expression (8) and Expression (9) are substituted into Expression (7), the second vehicle state equation is represented by Expression (10) below.

$$\dot{x} = {f}_{2} ( x , u ) = [ \begin{matrix}\begin{matrix}\begin{matrix}\begin{matrix}\begin{matrix}\begin{matrix}\begin{matrix}V cos ( θ + β ) \\ V sin ( θ + β )\end{matrix} \\ γ\end{matrix} \\ {a}_{x}\end{matrix} \\ - \frac{γ}{τ} + \frac{1}{τ} \cdot \frac{V}{{L}_{f} + {L}_{r}} tan ( δ )\end{matrix} \\ - \frac{β}{τ} + \frac{1}{τ} {tan}^{- 1} ( \frac{{L}_{r}}{{L}_{f} + {L}_{r}} tan ( δ ) )\end{matrix} \\ ω\end{matrix} \\ {j}_{x}\end{matrix} ] \qquad ( 10 )$$

In Expression (10), f₂ is a vector function of the second vehicle state equation. The first vehicle state equation of Expression (6) and the second vehicle state equation of Expression (10) include the same vehicle state quantity x and the same control input quantity u, but are different from each other in terms of arithmetic expressions related to the yaw rate γ and the sideslip angle β among the first state variables, which are the variables of the vehicle state quantity x. The first vehicle state equation and the second vehicle state equation are not limited to Expression (6) and Expression (10), respectively, and may be configured such that arithmetic expressions related to a part of or all of the state variables in the first state variables are different from each other. As an example, the second vehicle state equation may be a motion equation related to a lateral motion and a rotational motion of the vehicle at the time of steady-state circular turning, instead of Expression (10). This motion equation cannot express a transient motion, unlike the first vehicle state equation, but can accurately express a vehicle motion at a low vehicle speed. In this case, the second vehicle state equation is represented by Expression (11) below.

$$\dot{x} = [ \begin{matrix}\begin{matrix}\begin{matrix}\begin{matrix}\begin{matrix}\begin{matrix}\begin{matrix}V cos ( θ + β ) \\ V sin ( θ + β )\end{matrix} \\ γ\end{matrix} \\ {a}_{x}\end{matrix} \\ \frac{{γ}_{sst} - γ}{τ}\end{matrix} \\ \frac{{β}_{sst} - β}{τ}\end{matrix} \\ ω\end{matrix} \\ {j}_{x}\end{matrix} ] \qquad ( 11 )$$

In Expression (11), γₛₛₜ and βₛₛₜ are a yaw rate and a sideslip angle in a steady-state circular turning, respectively. The yaw rate γₛₛₜ and the sideslip angle βₛₛₜ are represented by Expression (12) and Expression (13) below, respectively.

$${γ}_{s s t} = \frac{1}{1 + A {V}^{2}} \cdot \frac{V}{{L}_{f} + {L}_{r}} δ \qquad ( 12 )$$

$${β}_{s s t} = \frac{1 + M {L}_{f} {V}^{2} / 2 ( {L}_{f} + {L}_{r} ) / {L}_{r} {K}_{r}}{1 + A {V}^{2}} \cdot \frac{{L}_{r}}{{L}_{f} + {L}_{r}} δ \qquad ( 13 )$$

In Expression (12) and Expression (13), A is a stability factor and is represented by Expression (14) below.

$$A = \frac{M}{2 {( {L}_{f} + {L}_{r} )}^{2}} \cdot \frac{{L}_{f} {K}_{f} - {L}_{r} {K}_{r}}{{K}_{f} {K}_{r}} \qquad ( 14 )$$

Since the first vehicle state equation of Expression (6) includes arithmetic expressions in which the value of the vehicle speed V diverges in the vicinity of 0 km/h, the accuracy at a low vehicle speed is deteriorated. On the other hand, in the second vehicle state equation of Expression (10), only variations in the yaw rate γ and the sideslip angle β due to the front wheel steering angle δ are considered, and the force generated in the vehicle are not considered, so that the accuracy at a high vehicle speed at which a centrifugal force is generated at the time of turning is deteriorated. Therefore, weighting is performed on the first vehicle state equation and the second vehicle state equation using a first weighting function of Expression (15) below so that the accuracy can be maintained at all vehicle speeds.

$$α = \frac{{V}^{2}}{{V}^{2} + {V}_{s}^{2}} \qquad ( 15 )$$

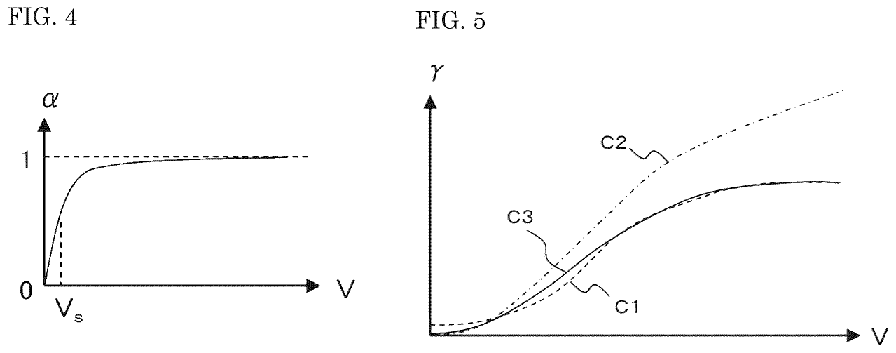

In Expression (15), Vₛ is a vehicle speed at which the vehicle state quantity when the first vehicle state equation is solved and the vehicle state quantity when the second vehicle state equation is solved coincide. FIG. 4 is a graph showing an example of the first weighting function α with respect to the vehicle speed V. The first weighting function α is a function of a speed and is set such that the first vehicle state equation is dominant at a high vehicle speed and the second vehicle state equation is dominant at a low vehicle speed. Further, the first weighting function α takes a value between 0 and 1. The first mixed state equation is generated by weighting the first vehicle state equation of Expression (6) and the second vehicle state equation of Expression (10) using the first weighting function of Expression (15). The first mixed state equation is represented by Expression (16) below.

$$\dot{x} = f ( x , u ) = α {f}_{1} ( x , u ) + ( 1 - α ) {f}_{2} ( x , u ) = [ \begin{matrix}\begin{matrix}\begin{matrix}\begin{matrix}\begin{matrix}\begin{matrix}\begin{matrix}\begin{matrix}V cos ( θ + β ) \\ V sin ( θ + β )\end{matrix} \\ γ\end{matrix} \\ {a}_{x}\end{matrix} \\ \begin{matrix}\frac{{V}^{2}}{{V}^{2} + {V}_{s}^{2}} ( - \frac{2}{IV} ( {K}_{f} {L}_{f}^{2} + {K}_{r} {L}_{r}^{2} ) γ - \frac{2}{I} ( {K}_{f} {L}_{f} - {K}_{r} {L}_{r} ) β + \\ \frac{2}{I} {K}_{f} {L}_{f} δ ) + \frac{{V}_{s}^{2}}{{V}^{2} + {V}_{s}^{2}} ( - \frac{γ}{τ} + \frac{1}{τ} \cdot \frac{V}{{L}_{f} + {L}_{r}} tan ( δ ) )\end{matrix}\end{matrix} \\ \frac{{V}^{2}}{{V}^{2} + {V}_{s}^{2}} ( - ( 1 + \frac{2 ( {K}_{f} {L}_{f} - {K}_{r} {L}_{r} )}{{MV}^{2}} ) γ - \frac{2}{MV} ( {K}_{f} + {K}_{r} ) β + \frac{2 {K}_{f}}{MV} δ ) +\end{matrix} \\ \frac{{V}_{s}^{2}}{{V}^{2} + {V}_{s}^{2}} ( - \frac{β}{τ} + \frac{1}{τ} {tan}^{- 1} ( \frac{{L}_{r}}{{L}_{f} + {L}_{r}} tan ( δ ) ) )\end{matrix} \\ ω\end{matrix} \\ {j}_{x}\end{matrix} ] \qquad ( 16 )$$

In Expression (16), f is a vector function of the first mixed state equation.

FIG. 5 is a graph showing an example of the yaw rate y with respect to the vehicle speed V in Embodiment 1. In FIG. 5, the horizontal axis represents the vehicle speed V, and the vertical axis represents the yaw rate γ. In addition, a broken line C1 in the graph is obtained when the yaw rate γ is solved from the first vehicle state equation of Expression (6). A dashed-dotted line C2 in the graph is obtained when the yaw rate γ is solved from the second vehicle state equation of Expression (10). A solid line C3 in the graph is obtained when the yaw rate γ is solved from the first mixed state equation of Expression (16).

The solid line C3 well coincides with the broken line C1 at a high vehicle speed, and well coincides with the dashed-dotted line C2 at a low vehicle speed. That is, by using the first mixed state equation of Expression (16), it is possible to calculate the yaw rate γ with high accuracy at any vehicle speed. In addition, the solid line C3 does not become discontinuous at a point at which the broken line C1 and the dashed-dotted line C2 intersect each other, that is, at a point at which the vehicle speed V is Vs. Further, in the first mixed state equation of Expression (16), since the vehicle state quantity x and the control input quantity u included in the first vehicle state equation and the second vehicle state equation are used, the calculation load hardly changes as compared with the case where the first vehicle state equation and the second vehicle state equation are individually calculated. Here, only the graph of the yaw rate γ is shown as one of the state variables having different arithmetic expressions in the first state variables, but the same result has been obtained for the sideslip angle β.

In the present embodiment, the first vehicle state equation and the second vehicle state equation are used as the vehicle state equations, and they should be multiple equations, and thus a third vehicle state equation may be added. For example, the third vehicle state equation is a motion equation having high accuracy for a vehicle speed between a high vehicle speed and a low vehicle speed. Also, the third vehicle state equation is to be weighted using the first weighting function.

In addition, the first weighting function is a function including a quadratic term of the vehicle speed V as shown in Expression (15), but is not limited to Expression (15) as long as the first weighting function is set to take a value between 0 and 1. For example, the first weighting function may be a function including a multiple order term, an exponential function, or the like, instead of the quadratic term of the vehicle speed V. The first weighting function may be a function of a part of the state variables in the first state variables, and may be a function other than the vehicle speed V. Furthermore, the first weighting function may be more than one. For example, two functions of Expression (17) and Expression (18) below may be set for the first weighting function.

$${α}_{1} = \frac{{V}^{2}}{{V}^{2} + {V}_{s 1}^{2}} \qquad ( 17 )$$

$${a}_{2} = \frac{{V}^{2}}{{V}^{2} + {V}_{s 2}^{2}} \qquad ( 18 )$$

In Expression (17), Vₛ₁ is a vehicle speed at which the yaw rate γ obtained when the first vehicle state equation is solved and the yaw rate γ obtained when the second vehicle state equation is solved coincide. In Expression (18), Vₛ₁ is a vehicle speed at which the sideslip angle β obtained when the first vehicle state equation is solved and the sideslip angle β obtained when the second vehicle state equation is solved coincide. The first mixed state equation is generated by weighting the first vehicle state equation and the second vehicle state equation using the weighting functions of Expression (17) and Expression (18). The first mixed state equation is represented by Expression (19) below.

$$\dot{x} = f ( x , u ) = [ \begin{matrix}\begin{matrix}\begin{matrix}\begin{matrix}\begin{matrix}\begin{matrix}\begin{matrix}\begin{matrix}V cos ( θ + β ) \\ V sin ( θ + β )\end{matrix} \\ γ\end{matrix} \\ {a}_{x}\end{matrix} \\ \begin{matrix}\frac{{V}^{2}}{{V}^{2} + {V}_{s 1}^{2}} ( - \frac{2}{IV} ( {K}_{f} {L}_{f}^{2} + {K}_{r} {L}_{r}^{2} ) γ - \frac{2}{I} ( {K}_{f} {L}_{f} - {K}_{r} {L}_{r} ) β + \\ \frac{2}{I} {K}_{f} {L}_{f} δ ) + \frac{{V}_{s}^{2}}{{V}^{2} + {V}_{s 1}^{2}} ( - \frac{γ}{τ} + \frac{1}{τ} \cdot \frac{V}{{L}_{f} + {L}_{r}} tan ( δ ) )\end{matrix}\end{matrix} \\ \frac{{V}^{2}}{{V}^{2} + {V}_{s 2}^{2}} ( - ( 1 + \frac{2 ( {K}_{f} {L}_{f} - {K}_{r} {L}_{r} )}{{MV}^{2}} ) γ - \frac{2}{MV} ( {K}_{f} + {K}_{r} ) β + \frac{2 {K}_{f}}{MV} δ ) +\end{matrix} \\ \frac{{V}_{s}^{2}}{{V}^{2} + {V}_{s 2}^{2}} ( - \frac{β}{τ} + \frac{1}{τ} {tan}^{- 1} ( \frac{{L}_{r}}{{L}_{f} + {L}_{r}} tan ( δ ) ) )\end{matrix} \\ ω\end{matrix} \\ {j}_{x}\end{matrix} ] \qquad ( 19 )$$

Next, the target value arithmetic unit 240 will be described. The target value arithmetic unit 240 calculates target control values for the vehicle to travel along the target route on the basis of the first mixed state equation of Expression (16) and the current value of each first state variable. Specifically, the target value arithmetic unit 240 predicts the behavior of the vehicle from the current time 0 up to a predetermined time N·dt seconds at intervals of a predetermined period dt seconds and solves an optimization problem for every certain period for obtaining a control input quantity u that minimizes the evaluation function, thereby calculating optimal target control values. The target control values are a target steering amount and a target acceleration/deceleration amount. The target value arithmetic unit 240 solves a constrained optimization problem represented by Expression (20) below for every certain period.

$${min}_{x , u} J s . t . \dot{x} = f ( x , u ) , \qquad ( 20 )$$

$${x}_{0} = x ( 0 ) ,$$

$$g ( x , u ) \leq 0$$

In Expression (20), J is an evaluation function, x₀ is an initial value, and g is a vector function related to a constraint. The initial value x₀ corresponds to a current value of each first state variable at the time 0. In the present embodiment, the optimization problem in Expression (20) is treated as a minimization problem, but can also be treated as a maximization problem by inverting the sign of the evaluation function J. As the evaluation function J, Expression (21) below is used.

$$J = {( {h}_{N} ( {x}_{N} ) - {r}_{N} )}^{T} {W}_{N} ( {h}_{N} ( {x}_{N} ) - {r}_{N} ) + {{\sum }_{k = 0}}^{N - 1} {( h ( {x}_{k} , {u}_{k} ) - {r}_{k} )}^{T} W ( h ( {x}_{k} , {u}_{k} ) - {r}_{k} ) \qquad ( 21 )$$

In Expression (21), k is a prediction point that takes a value between 0 to N, and N is a terminal point. xₖ is a vehicle state quantity at the prediction point k, uₖ is a control input quantity at the prediction point k, h is a vector function related to an evaluation item, h_{N} is a vector function related to an evaluation item at the terminal point, rₖ is a target value at the prediction point k, r_{N} is a target value at the terminal point, W is a diagonal matrix having a weight for each evaluation item at the prediction point k as a diagonal component, and W_{N} is a diagonal matrix having a weight for each evaluation item at the terminal point as a diagonal component. The matrices W and W_{N} can be modified as needed as parameters. The vector functions h and h_{N} related to the evaluation items are set by Expression (22) and Expression (23) below, respectively.

h=[e_{Y,k},e_{θ,k},ωₖ,e_{V,k},jₖ]^{T} (22)

h_{N}=[e_{Y,N},e_{θ,N}e_{V,N}]^{T} (23)

In Expression (22), e_{γ,k}, e_{θ,k}, and e_{V,k} are tracking errors with respect to the target route, the target azimuth, and the target vehicle speed at the prediction point k, respectively. ωₖ is a front wheel steering angular velocity at the prediction point k, and jₖ is a longitudinal jerk at the prediction point k. The target values rₖ and r_{N} are set as Expression (24) and Expression (25) below so that the route tracking error e_{γ, k}, the azimuth tracking error e_{θ, k}, the vehicle speed tracking error e_{V,k}, the front wheel steering angular velocity ωₖ, and the longitudinal jerk jₖ can be small.

rₖ=[0,0,0,0,0]^{T} (k=0, . . . ,N−1) (24)

r_{N}=[0,0,0]^{T} (25)

Here, the route tracking error e_{γ,k}, the azimuth tracking error e_{θ,k}, the vehicle speed tracking error e_{V,k}, the front wheel steering angular velocity ωₖ, and the longitudinal jerk jₖ are set to be evaluated. However, in order to improve the ride comfort of a vehicle, the longitudinal acceleration aₓ, the yaw rate γ, and the like may be added to the evaluation items.

The vector function g is used to set upper and lower limit values of the vehicle state quantity x and the control input quantity u in the constrained optimization problem, and optimization is performed under the condition of g (x, u)≤0. The vector function g is set by Expression (26) below.

$$g = [ \begin{matrix}ω - {ω}_{max} \\ - ω + {ω}_{min} \\ j - {j}_{max} \\ - j + {j}_{min}\end{matrix} ] \qquad ( 26 )$$

In Expression (26), ωₘₐₓ and ωₘᵢₙ are an upper limit value and a lower limit value of the front wheel steering angular velocity, respectively. jₘₐₓ and jₘᵢₙ are an upper limit value and a lower limit value of the longitudinal jerk, respectively. By setting the upper and lower limit values of the front wheel steering angular velocity ωₖ and the longitudinal jerk jₖ, it is possible to perform vehicle control for securing the ride quality of the vehicle. Note that upper and lower limit values may also be set for the longitudinal acceleration aₓ, the yaw rate γ, and the like in order to further improve the ride quality, and upper and lower limit values may also be set for the vehicle speed V in order to strictly observe the speed limits.

The target value arithmetic unit 240 may calculate the target control values using the first mixed state equation by any method other than the method of solving the constrained optimization problem represented by Expression (20) for every certain period. For example, they are known methods such as an optimal regulator and H_{∞} control. Even in this case, the target value arithmetic unit 240 calculates the target control values on the basis of the first mixed state equation and a current value of each first state variable.

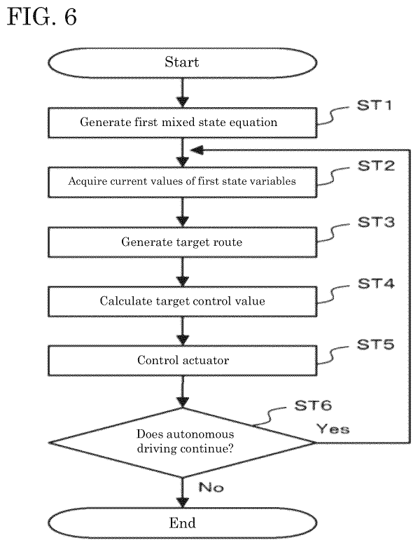

FIG. 6 is a flowchart showing an example of a procedure of autonomous driving in Embodiment 1.

As shown in FIG. 6, when autonomous driving is started by a means (not shown), the mixed state equation generation unit 210 generates the first mixed state equation by weighting a plurality of vehicle state equations using the first weighting function (step ST1). The plurality of vehicle state equations are, for example, the first vehicle state equation of Expression (6) and the second vehicle state equation of Expression (10).

The vehicle state acquisition unit 220 acquires a current value of each first state variable by the internal sensors 110 (step ST2).

The target route generation unit 230 generates a target route of the vehicle on the basis of peripheral information acquired by the external sensors 120 (step ST3).

The target value arithmetic unit 240 calculates target control values for the vehicle to travel along the target route on the basis of the first mixed state equation and the current value of each first state variable (step ST4). That is, the target value arithmetic unit 240 calculates the target control values by solving the optimizing problem of Expression (20).

The control unit 310 controls the actuator so that the vehicle can follow the target control values (step ST5).

A means (not shown) determines whether or not to continue the autonomous driving (step ST6).

In a case when the determination in step ST6 is “Yes”, the process returns to step ST2, and the autonomous driving is continued.

In a case when the determination in step ST6 is “No”, the autonomous driving is terminated. For example, when it is determined that the vehicle deviates from the target route and does not travel properly, it is a case where the autonomous driving is forcibly terminated. In this case, such a process to temporarily stop the vehicle at the time of the event is to be executed.

According to Embodiment 1 described above, since the first mixed state equation is generated by weighting the plurality of vehicle state equations using the first weighting function, and the target control values are calculated using the first mixed state equation, it is possible to accurately calculate the target control values while an increase in the calculation load is suppressed.

### Embodiment 2

In Embodiment 1, all the variables of the vehicle state quantity x in Expression (1) are the first state variables that are acquisition targets of the internal sensors 110, but there is a case where the vehicle state quantity x cannot be normally acquired due to measurement errors of the internal sensors 110 or the like. In such a case, a state variable that cannot be normally acquired is estimated by a vehicle state estimation unit 260 to be described later.

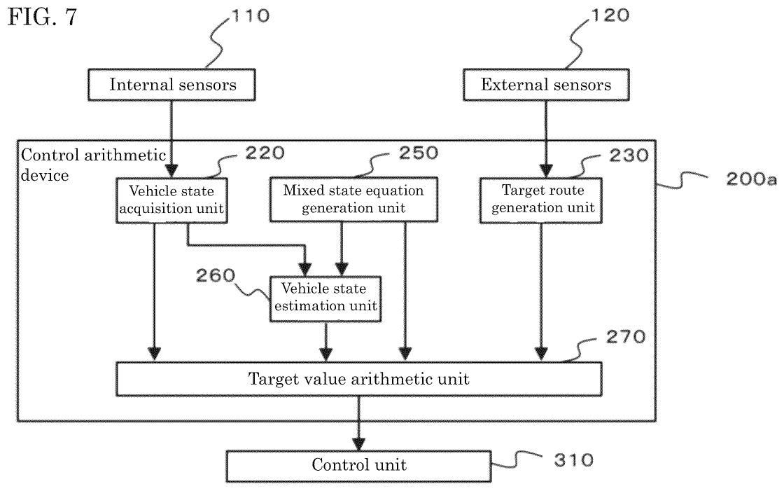

FIG. 7 is a block diagram showing an example of a control arithmetic device 200a according to Embodiment 2. FIG. 7 is different from FIG. 1 in that the vehicle state estimation unit 260 is provided, a mixed state equation generation unit 250 is provided instead of the mixed state equation generation unit 210, and a target value arithmetic unit 270 is provided instead of the target value arithmetic unit 240. The components other than the mixed state equation generation unit 250, the vehicle state estimation unit 260, and the target value arithmetic unit 270 are the same as those shown in FIG. 1, and thus the description thereof will be omitted.

The mixed state equation generation unit 250 generates a plurality of vehicle state equations each including one or more first state variables that are acquisition targets of the internal sensors 110 installed in the vehicle and one or more second state variables to be estimated but are not acquisition targets by the internal sensors 110. The mixed state equation generation unit 250 generates a first mixed state equation by weighting each of the vehicle state equations using the first weighting function. The mixed state equation generation unit 250 outputs the first mixed state equation to the vehicle state estimation unit 260 and the target value arithmetic unit 270. The first state variables are state variables that are normally acquired by the internal sensors 110, and the second state variables are state variables that are not normally acquired owing to measurement errors of the internal sensors 110 or the like. That is, the vehicle state quantity x in Expression (1) is composed of the first state variables and the second state variables. The number of the first state variables may be one or more, and the number of the second state variables may be one or more.

Here, the vehicle state equations are the first vehicle state equation of Expression (6) and the second vehicle state equation of Expression (10) but are not limited thereto. It is only necessary that arithmetic expressions related to a part of or all of the state variables in the first state variables and the second state variables are configured to be different. In addition, the first weighting function is a function of a part of the state variables in the first state variables and the second state variables. In other words, the first weighting function may be a function of a part of the first state variables, a function of a part of the second state variables, or a function of a part of the first state variables and a part of the second state variables.

The vehicle state estimation unit 260 estimates a current value of each second state variable on the basis of the first mixed state equation and a current value of each first state variable. The vehicle state estimation unit 260 outputs the current value of each second state variable to the target value arithmetic unit 270. As an example, it is assumed that the internal sensors 110 for acquiring positions X and Y of the center of gravity, the azimuth angle θ, the vehicle speed V, the front wheel steering angle δ, and the longitudinal acceleration aₓ are normal, and measurement errors occur in the internal sensors 110 for acquiring the yaw rate γ and the sideslip angle β. In this case, the first state variables are the positions X and Y of the center of gravity, the azimuth angle θ, the vehicle speed V, the front wheel steering angle δ, and the longitudinal acceleration aₓ. The second state variables are the yaw rate y and the sideslip angle β. The current values of the first state variables are acquired by the vehicle state acquisition unit 220. The current values of the second state variables are estimated by a known method on the basis of the first mixed state equation and the current value of each first state variable. Examples of the known methods include a Kalman filter, a particle filter, and moving horizon estimation (MHE), etc. Here, the state variables that are not normally acquired are set as the second state variables, but the state variables that are normally acquired may also be estimated as the second state variables. Further, the vehicle state estimation unit 260 may be included in the target value arithmetic unit 270.

On the basis of the first mixed state equation, the current value of each first state variable, and the current value of each second state variable, the target value arithmetic unit 270 calculates target control values for the vehicle to travel along a target route, and outputs the target control values to the control unit that controls the vehicle. The target value arithmetic unit 270 calculates the target control values by solving the constrained optimization problem represented by Expression (20) for every certain period. Note that, in Expression (20), the initial values x₀ are the current value of each first state variable and the current value of each second state variable at the time 0.

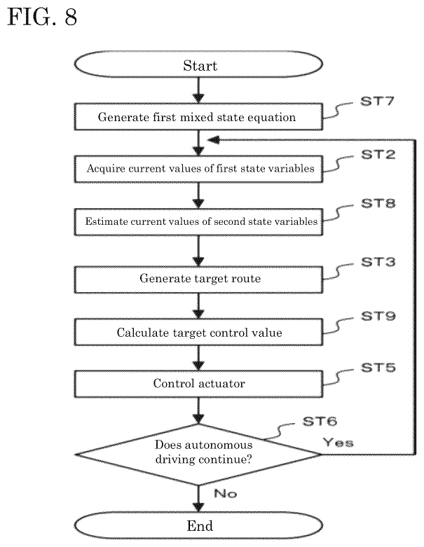

FIG. 8 is a flowchart showing an example of a procedure of autonomous driving in Embodiment 2. Since steps ST2, ST3, ST5, and ST6 in FIG. 8 are the same as steps ST2, ST3, ST5, and ST6 in FIG. 6, the detailed description thereof will be omitted here.

As shown in FIG. 8, when autonomous driving is started by a means (not shown), the mixed state equation generation unit 250 generates the first mixed state equation by weighting a plurality of vehicle state equations using the first weighting function (step ST7). The plurality of vehicle state equations are, for example, the first vehicle state equation of Expression (6) and the second vehicle state equation of Expression (10).

The vehicle state acquisition unit 220 acquires the current value of each first state variable by the internal sensors 110 (step ST2).

The vehicle state estimation unit 260 estimates the current value of each second state variable on the basis of the first mixed state equation and the current value of each first state variable (step ST8).

The target route generation unit 230 generates a target route of the vehicle on the basis of the peripheral information acquired by the external sensors 120 (step ST3).

On the basis of the first mixed state equation, the current value of each first state variable, and the current value of each second state variable, the target value arithmetic unit 270 calculates target control values for the vehicle to travel along the target route (step ST9). That is, the target value arithmetic unit 270 calculates the target control values by solving the optimization problem represented by Expression (20).

The control unit 310 controls the actuator so that the vehicle can follow the target control values (step ST5).

A means (not shown) determines whether or not to continue the autonomous driving (step ST6).

In a case when the determination in step ST6 is “Yes”, the process returns to step ST2 and the autonomous driving is continued, and in a case when the determination in step ST6 is “No”, the autonomous driving is terminated.

In the process described above, the current values of the second state variables are estimated using the first mixed state equation, and the target control values are calculated. Instead, the current values of the second state variables are estimated using the first mixed state equation and target control values may be calculated using a second mixed state equation. The second mixed state equation is composed of a part of the arithmetic expressions of the first mixed state equation. That is, the mixed state equation generation unit 250 generates the second mixed state equation composed of a part of the arithmetic expressions of the first mixed state equation. The mixed state equation generation unit 250 outputs the first mixed state equation to the vehicle state estimation unit 260, and outputs the second mixed state equation to the target value arithmetic unit 270. Further, the target value arithmetic unit 270 calculates the target control values on the basis of the first mixed state equation, the second mixed state equation, the current value of each first state variable, and the current value of each second state variable. Specifically, the target value arithmetic unit 270 calculates the target control values on the basis of the second mixed state equation, the current value of each first state variable, and the current value of each second state variable estimated by the first mixed state equation and each first state variable. As an example, in contrast to the first mixed state equation of Expression (16), the second mixed state equation is represented by Expression (27) below.

$$[ \begin{matrix}\dot{θ} \\ \dot{V} \\ \dot{γ} \\ \dot{β} \\ \dot{δ} \\ {\dot{a}}_{x}\end{matrix} ] = [ \begin{matrix}\begin{matrix}\begin{matrix}\begin{matrix}\begin{matrix}\begin{matrix}γ \\ {a}_{x}\end{matrix} \\ \begin{matrix}\frac{{V}^{2}}{{V}^{2} + {V}_{s}^{2}} ( - \frac{2}{IV} ( {K}_{f} {L}_{f}^{2} + {K}_{r} {L}_{r}^{2} ) γ - \frac{2}{I} ( {K}_{f} {L}_{f} - {K}_{r} {L}_{r} ) β + \\ \frac{2}{I} {K}_{f} {L}_{f} δ ) + \frac{{V}_{s}^{2}}{{V}^{2} + {V}_{s}^{2}} ( - \frac{γ}{τ} + \frac{1}{τ} \cdot \frac{V}{{L}_{f} + {L}_{r}} tan ( δ ) )\end{matrix}\end{matrix} \\ \frac{{V}^{2}}{{V}^{2} + {V}_{s}^{2}} ( - ( 1 + \frac{2 ( {K}_{f} {L}_{f} - {K}_{r} {L}_{r} )}{{MV}^{2}} ) γ - \frac{2}{MV} ( {K}_{f} + {K}_{r} ) β + \frac{2 {K}_{f}}{MV} δ ) +\end{matrix} \\ \frac{{V}_{s}^{2}}{{V}^{2} + {V}_{s}^{2}} ( - \frac{β}{τ} + \frac{1}{τ} {tan}^{- 1} ( \frac{{L}_{r}}{{L}_{f} + {L}_{r}} tan ( δ ) ) )\end{matrix} \\ ω\end{matrix} \\ {j}_{x}\end{matrix} ] \qquad ( 27 )$$

In Expression (27), the second mixed state equation is obtained by deleting the arithmetic expressions related to the positions X and Y of the center of gravity of the vehicle from the first mixed state equation of Expression (19).

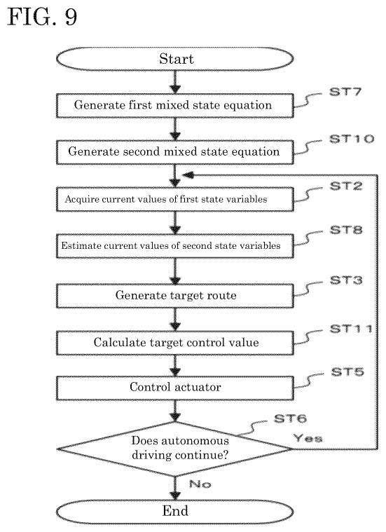

FIG. 9 is a flowchart showing another example of a procedure of autonomous driving according to Embodiment 2. Specifically, FIG. 9 is a flowchart in a case where the mixed state equation generation unit 250 generates the second mixed state equation. Steps ST2, ST3, ST5, ST6, ST7, and ST8 in FIG. 9 are the same as steps ST2, ST3, ST5, ST6, ST7, and ST8 in FIG. 8, and thus the detailed description thereof will be omitted here.

As shown in FIG. 9, when autonomous driving is started by a means (not shown), the mixed state equation generation unit 250 generates the first mixed state equation (step ST7).

The mixed state equation generation unit 250 generates the second mixed state equation composed of a part of the arithmetic expressions of the first mixed state equation (step ST10).

The vehicle state acquisition unit 220 acquires the current value of each first state variable by the internal sensors 110 (step ST2).

The vehicle state estimation unit 260 estimates the current value of each second state variable on the basis of the first mixed state equation and the current value of each first state variable (step ST8).

The target route generation unit 230 generates a target route of the vehicle on the basis of the peripheral information acquired by the external sensors 120 (step ST3).

The target value arithmetic unit 270 calculates target control values for the vehicle to travel along the target route on the basis of the second mixed state equation, the current value of each first state variable, and the current value of each second state variable (step ST11). When the vehicle state estimation unit 260 is included in the target value arithmetic unit 270, the process of step ST8 is not necessary. Instead, in step ST11, the target value arithmetic unit 270 calculates the target control values on the basis of the first mixed state equation, the second mixed state equation, the current value of each first state variable, and the current value of each second state variable.

The control unit 310 controls the actuator so that the vehicle can follow the target control values (step ST5).

A means (not shown) determines whether or not to continue the autonomous driving (step ST6).

In a case when the determination in step ST6 is “Yes”, the process returns to step ST2 and the autonomous driving is continued, and in a case when the determination in step ST6 is “No”, the autonomous driving is terminated.

As described above, by using the second mixed state equation in the calculation of the target control values, the calculation load can be suppressed.

According to Embodiment 2 described above, by estimating the current values of the second state variables on the basis of the first mixed state equation and the current value of each first state variable, even the state variables that are not normally acquired by the internal sensors 110 can also be estimated with high accuracy.

### Embodiment 3

In Embodiment 1 and Embodiment 2, the target route is generated on the basis of the peripheral information acquired by the external sensors 120. However, there is a case where the target route cannot be normally acquired owing to measurement errors of the external sensors 120 or the like. In such a case, state variables that cannot be normally acquired are estimated and the target route is generated by the target route generation unit 290 to be described later.

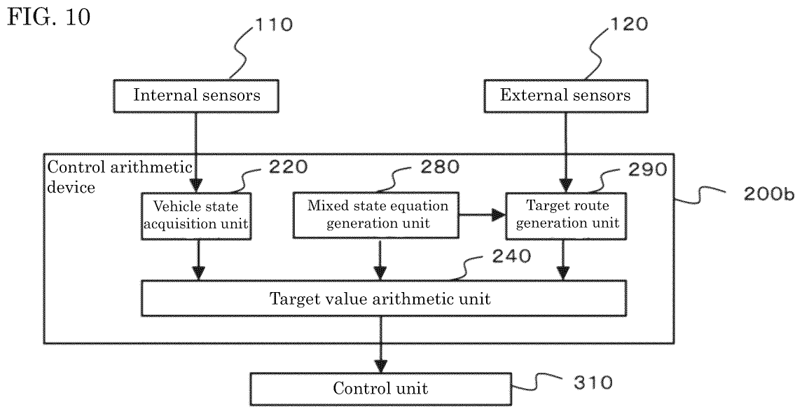

FIG. 10 is a block diagram showing an example of a control arithmetic device 200b according to Embodiment 3. FIG. 10 is different from FIG. 1 in that a mixed state equation generation unit 280 is provided in place of the mixed state equation generation unit 210 and a target route generation unit 290 is provided in place of the target route generation unit 230. The components other than the mixed state equation generation unit 280 and the target route generation unit 290 are the same as those shown in FIG. 1, and thus the description thereof is omitted.

The mixed state equation generation unit 280 generates a plurality of peripheral state equations each including one or more third state variables that are acquisition targets of the external sensors 120 installed in the vehicle and one or more fourth state variables that are not acquisition targets of the external sensors 120 but estimation targets. The mixed state equation generation unit 280 generates a third mixed state equation by weighting each of the peripheral state equations using a second weighting function. The mixed state equation generation unit 280 outputs the third mixed state equation to the target route generation unit 290 and the target value arithmetic unit 240. The third mixed state equation can be applied, in particular, to the information on other vehicles among the peripheral information acquired by the external sensors 120. The third state variables are state variables that are normally acquired by the external sensors 120. The fourth state variables are state variables that are not normally acquired owing to measurement errors of the external sensors 120 or the like. The vehicle state quantity x included in the peripheral state equations is composed of the third state variables and the fourth state variables. That is, the mixed state equation generation unit 280 generates the third mixed state equation in addition to the first mixed state equation in Embodiment 1 or Embodiment 2 and the second mixed state equation in Embodiment 2. The number of the third state variables may be one or more, and the number of the fourth state variables may be one or more.

The vehicle state equations in Embodiment 1 or Embodiment 2 may be the same as or different from the peripheral state equations in Embodiment 3. Note that the peripheral state equations are configured such that arithmetic expressions related to a part of or all of the state variables in the third state variables and the fourth state variables are to be different. In addition, the first weighting function in Embodiment 1 or Embodiment 2 may be the same as or different from the second weighting function in Embodiment 3. Note that the second weighting function is a function of a part of the state variables in the third state variables and the fourth state variables. In other words, the second weighting function may be a function of a part of the third state variables, a function of a part of the fourth state variables, or a function of a part of the third state variables and a part of the fourth state variables. Similarly, the first mixed state equation and the third mixed state equation may be the same or different. In a case where the first mixed state equation and the third mixed state equation are the same, the second mixed state equation is different from the third mixed state equation. In a case where the first mixed state equation is different from the third mixed state equation, the second mixed state equation and the third mixed state equation may be the same or different.

The target route generation unit 290 acquires the current value of each third state variable by the external sensors, estimates the current value of each fourth state variable on the basis of the third mixed state equation and the current value of each third state variable, and generates a target route on the basis of the current value of each third state variable and the current value of each fourth state variable. The target route generation unit 290 outputs the target route to the target value arithmetic unit 240. The method of estimating the current values of the fourth state variables is, for example, a known method such as a Kalman filter, a particle filter, and MHE, etc.

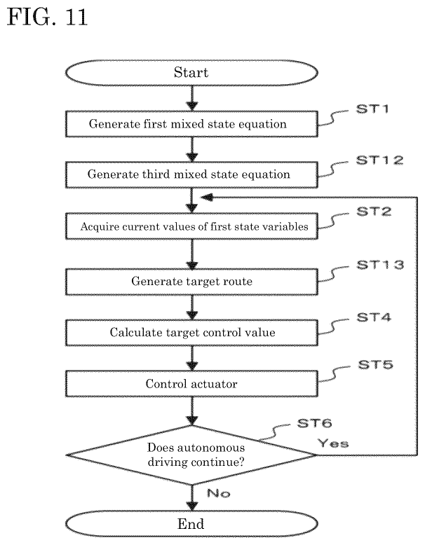

FIG. 11 is a flowchart showing an example of a procedure of autonomous driving in Embodiment 3. Since steps ST1, ST2, ST4, ST5, and ST6 in FIG. 11 are the same as steps ST1, ST2, ST4, ST5, and ST6 in FIG. 6, the detailed description thereof will be omitted here.

As shown in FIG. 11, when autonomous driving is started by a means (not shown), the mixed state equation generation unit 280 generates the first mixed state equation (step ST1).

The mixed state equation generation unit 280 generates the third mixed state equation by weighting the plurality of peripheral state equations using the second weighting function (step ST12).

The vehicle state acquisition unit 220 acquires the current value of each first state variable by the internal sensors 110 (step ST2).

The target route generation unit 290 acquires the current value of each third state variable by the external sensors, estimates the current value of each fourth state variable on the basis of the third mixed state equation and the current value of each third state variable, and generates a target route on the basis of the current value of each third state variable and the current value of each fourth state variable (step ST13).

The target value arithmetic unit 240 calculates target control values for the vehicle to travel along the target route on the basis of the first mixed state equation and the current value of each first state variable (step ST4).

The control unit 310 controls the actuator so that the vehicle can follow the target control values (step ST5).

A means (not shown) determines whether or not to continue the autonomous driving (step ST6).

In a case when the determination in step ST6 is “Yes”, the process returns to step ST2 and the autonomous driving is continued, and in a case when the determination in step ST6 is “No”, the autonomous driving is terminated.

Note that FIG. 11 is a flowchart in a case where the mixed state equation generation unit 280 and the target route generation unit 290 are applied to Embodiment 1, but the mixed state equation generation unit 280 and the target route generation unit 290 can also be applied to Embodiment 2.

According to Embodiment 3 described above, the third mixed state equation is generated by weighting the plurality of peripheral state equations using the second weighting function, the current values of the fourth state variables are estimated on the basis of the third mixed state equation and the current value of each third state variable, and the target route is generated on the basis of the current values of the third state variables and the current values of the fourth state variables. Therefore, since the target route is generated also using the state variables other than the third state variables that are acquisition targets of the external sensors, the target route can be generated with high accuracy.

Here, a hardware configuration of the control arithmetic devices 200, 200a, and 200b, and the control unit 310 in Embodiment 1 to Embodiment 3 will be described. Each function of the control arithmetic devices 200, 200a, and 200b, and the control unit 310 can be implemented by processing circuitry. The processing circuitry includes at least one processor and at least one memory.

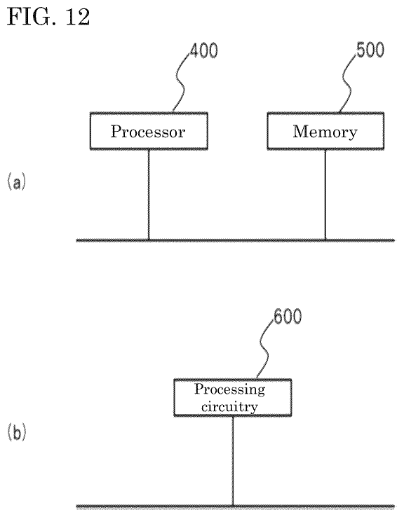

FIG. 12 is a diagram showing a hardware configuration of the control arithmetic devices 200, 200a, and 200b, and the control unit 310 according to Embodiment 1 to Embodiment 3. The control arithmetic devices 200, 200a, and 200b, and the control unit 310 can be implemented by a processor 400 and a memory 500 illustrated in FIG. 12(a). The processor 400 is, for example, a CPU (also referred to as a Central Processing Unit, a central processing device, a processing device, an arithmetic device, a microprocessor, a microcomputer, a processor, a DSP (Digital Signal Processor)) or a system LSI (Large Scale Integration).

The memory 500 is, for example, a nonvolatile or volatile semiconductor memory such as a random access memory (RAM), a read only memory (ROM), a flash memory, an erasable programmable read only memory (EPROM), or an electrically erasable programmable read only memory (EEPROM (registered trademark)), a hard disk drive (HDD), a magnetic disk, a flexible disk, an optical disc, a compact disc, a mini disc, or a digital versatile disc (DVD).

The function of each unit in the control arithmetic devices 200, 200a, and 200b, and the control unit 310 is implemented by software or the like (software, firmware, or software and firmware). The software or the like is written as a program and stored in the memory 500. The processor 400 implements the function of each unit by reading and executing the program stored in the memory 500. That is, it can be said that the program causes a computer to execute the procedure or the method of the control arithmetic devices 200, 200a, and 200b, and the control unit 310.

The program executed by the processor 400 may be provided as a computer program product stored in a computer-readable storage media as a file in an installable format or an executable format. Further, the program executed by the processor 400 may be provided to the control arithmetic devices 200, 200a, and 200b, and the control unit 310 via a network such as the Internet.

The control arithmetic devices 200, 200a, and 200b, and the control unit 310 may be implemented by dedicated processing circuitry 600 shown in FIG. 12(b). When the processing circuitry 600 is dedicated hardware, the processing circuitry 600 corresponds to, for example, a single circuit, a composite circuit, a programmed processor, a parallel programmed processor, an application specific integrated circuit (ASIC), a field programmable gate array (FPGA), or a combination thereof.

In the above, the configuration in which the function of each component of the control arithmetic devices 200, 200a, and 200b, and the control unit 310 is implemented by any one of software and hardware has been described. However, this is not a limitation, and a configuration in which some components of the control arithmetic devices 200, 200a, and 200b, and the control unit 310 are implemented by software or the like and other components thereof are implemented by dedicated hardware may be employed.

### DESCRIPTION OF REFERENCE NUMERALS AND SIGNS

110: internal sensor, 120: external sensor, 200, 200a, 200b: control arithmetic device, 210, 250, 280: mixed state equation generation unit, 220: vehicle state acquisition unit, 230, 290: target route generation unit, 240, 270: target value arithmetic unit, 310: control unit, 400: processor, 500: memory, 600: processing circuitry

1. A control arithmetic device comprising:
mixed state equation generation circuitry to generate a plurality of state equations each including one or more first state variables that are acquisition targets of one or more internal sensors, and generate a first mixed state equation by weighting each of the state equations using a first weighting function;
state acquisition circuitry to acquire a current value of each of the first state variables by the one or more internal sensors;
target route generation circuitry to generate a target route based on peripheral information acquired by one or more external sensors; and
target value arithmetic circuitry to calculate a target control value to travel along the target route based on the first mixed state equation and the current value of each of the first state variables.

2. A control arithmetic device comprising:
mixed state equation generation circuitry to generate a plurality of state equations each including one or more first state variables that are acquisition targets of one or more internal sensors and one or more second state variables that are not the acquisition targets of the one or more internal sensors but are estimation targets, and generate a first mixed state equation by weighting each of the state equations using a first weighting function;
state acquisition circuitry to acquire a current value of each of the first state variables by the one or more internal sensors;
state estimation circuitry to estimate a current value second state variables based on the first mixed state equation and the current value of each of the first state variables;
target route generation circuitry to generate a target route based on peripheral information acquired by one or more external sensors; and
target value arithmetic circuitry to calculate a target control value to travel along the target route based on the first mixed state equation, the current value of each of the first state variables, and the current value of each of the second state variables.

3. The control arithmetic device according to claim 2, wherein
the mixed state equation generation circuitry generates a second mixed state equation including a part of arithmetic expressions in the first mixed state equation, and
the target value arithmetic circuitry calculates the target control value based on the first mixed state equation, the second mixed state equation, the current value of each of the first state variables, and the current value of each of the second state variables.

4. The control arithmetic device according to claim 1, wherein arithmetic expressions related to a part of or all of state variables in the first state variables are configured to be different between each of the state equations.

5. The control arithmetic device according to claim 2, wherein arithmetic expressions related to a part of or all of state variables in the first state variables and the second state variables are configured to be different between each of the state equations.

6. The control arithmetic device according to claim 1, wherein the first weighting function is a function of a part of state variables in the first state variables.

7. The control arithmetic device according to claim 2, wherein the first weighting function is a function of a part of state variables in the first state variables and the second state variables.

8. The control arithmetic device according to claim 1, wherein
the mixed state equation generation circuitry generates a plurality of peripheral state equations each including one or more third state variables that are the acquisition targets of the one or more external sensors and one or more fourth state variables that are estimation targets but not the acquisition targets of the one or more external sensors, and generates a third mixed state equation by weighting each of the peripheral state equations using a second weighting function, and
the target route generation circuitry acquires a current value of each of the third state variables by the one or more external sensors, estimates a current value of each of the fourth state variables based on the third mixed state equation and the current value of each of the third state variables, and generates the target route based on the current value of each of the third state variables and the current value of each of the fourth state variables.

9. The control arithmetic device according to claim 8, wherein arithmetic expressions related to a part of or all of state variables in the third state variables and the fourth state variables are configured to be different between each of the peripheral state equations.

10. The control arithmetic device according to claim 8, wherein the second weighting function is a function of a part of state variables in the third state variables and the fourth state variables.
